(19) United States
(12) Patent Application Publication
(10) Pub. No.: US 2008/0238083 A1
(43) Pub. Date: Oct. 2, 2008

(54) Labeled Baggage

(76) Inventor: Michelle R. Warford, Burlingame, CA (US)

Correspondence Address: CARDINAL LAW GROUP, Suite 2000, 1603 Orrington Avenue, Evanston, IL, 60201, US

(21) Appl. No.: 11/691,286

(22) Filed: Mar. 26, 2007

(51) Int. Cl. B42D 15/00

(52) U.S. Cl. 283/81

(57) ABSTRACT

Labeled baggage includes a label with a non-fibrous polymer layer, visible indicia on the obverse of the label and an adhesive layer on the reverse of the label that bonds the label to a piece of baggage. The label sticks to the baggage during ordinary use, yet can be removed at room temperature, without the use of solvents, and without damaging the baggage. High or low friction materials can be used for the label surface to enhance or retard the tendency of the baggage to slide, as desired. Generally the labels are on an outside, conspicuous, surface of the baggage; but labels can also be placed on an inner surface of the baggage.

### FIELD OF THE INVENTION

This invention relates to labeled baggage including a label with a non-fibrous polymer layer, indicia on the obverse of the label and an adhesive layer on the reverse of the label.

### BACKGROUND OF THE INVENTION

Many styles of baggage are commercially available, nevertheless for an individual to quickly identify their own baggage among many others can be difficult. In areas such as airport baggage collection areas similar-looking bags can be easily confused. Difficulty in identifying one's bags can be a minor inconvenience, or even a significant security issue.

Methods of customizing baggage have included tags, typically affixed by transporters, such as cruise lines and airlines. These types of tags are intended to be easily and quickly attached and removed from luggage, and must be human or machine readable so that the luggage can be properly sorted and shipped to the intended destination.

U.S. Pat. No. 6,364,365 B1 (Caplan) discloses a luggage identification system, that includes adhesive stickers, tape, tags and so forth, each bearing its own distinctive pattern to aid in the rapid identification of pieces of luggage.

Commonly available adhesive stickers are generally ineffective means of decorating bags and luggage. It is difficult to smoothly apply the stickers; and the stickers are not durable in moist conditions or when exposed to temperature extremes. Furthermore the stickers tend to either prematurely release from the baggage, or can only partially be removed, leaving unsightly, sticky residue.

Prior art means of applying a label to baggage include stitch bonding and adhesive bonding. Either method typically resulted in a permanent bond; the label could not be removed without damaging or leaving residue on the bag.

There remains a need for a labeling system for baggage that is attractive, distinctive, easily affixed to baggage, and has sufficient durability to withstand rough handling in extreme conditions, yet can be cleanly removed when so desired.

### SUMMARY OF THE INVENTION

In a first aspect of the invention, a piece of labeled baggage includes the baggage itself and a label portion, bonded together with adhesive. A section of the baggage is designated as the labeling surface; this is the position to which the label is attached. The label portion includes a reverse side, in contact with the adhesive layer, a non-fibrous polymer layer and indicia that are visible when the obverse of the label is viewed. The entire adhesive layer is in contact or near the labeling surface of the baggage.

In a second aspect of the invention, a piece of labeled baggage includes the baggage itself and a label portion, bonded together with adhesive. A section of the baggage is designated as the labeling surface; this is the position to which the label is attached. The label portion includes a reverse side, in contact with the adhesive layer, a 0.2 mm to 10 mm thick non-fibrous polymer layer and indicia that are visible when the obverse of the label is viewed. The adhesive layer is 0.5 mm to 1.5 mm thick, and the entire adhesive layer is in contact or near the labeling surface of the baggage. Additionally the label can be removed from the baggage by pulling the label off the baggage at about 22° C. without the use of solvents or abrasives, without damaging the baggage, and without leaving noticeable residue on the baggage

### BRIEF DESCRIPTION OF THE DRAWINGS

The present invention will be more fully understood and further advantages will become apparent when reference is made to the following detailed description of the invention and the accompanying drawings, not drawn to scale. The drawings are merely representative and are not intended to limit the scope of the invention. Throughout the figures, like reference numbers refer to like elements.

FIGS. 1A to 1C: representatively illustrate perspective views of examples of labeled baggage in accordance with the present invention;

FIG. 2: representatively illustrates plan views of labels showing representative shapes and suggesting indicia which may be used on labels of the present invention;

FIGS. 3A to 3D: representatively illustrate cross sectional views of the present invention; and

FIG. 4: representatively illustrates a perspective view of an example of baggage highlighting labeling surfaces.

### DETAILED DESCRIPTION

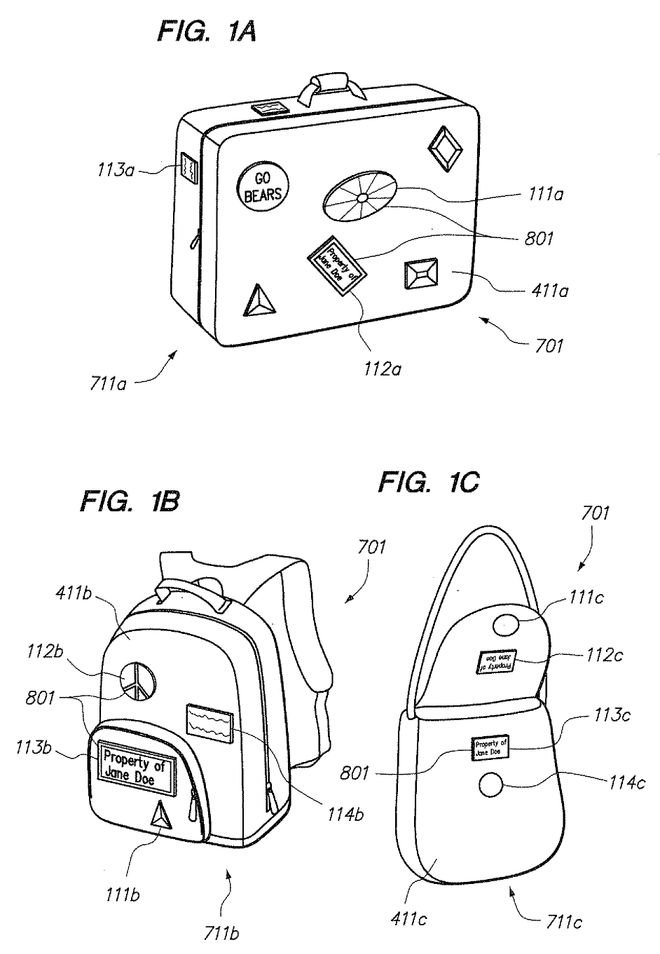

FIG. 1A representatively illustrates a perspective view of labeled baggage 701 in accordance with the present invention. The labeled baggage includes a suitcase, 711a, with an exterior surface 411a, upon which are a plurality of labels including labels 111a, 112a, 113a. The labels include visible indicia 801.

FIG. 1B representatively illustrates a perspective view of labeled baggage 701 in accordance with the present invention. The labeled baggage includes a backpack, 711b, with an exterior surface 411b, upon which are a plurality of labels including labels 111b, 112b, 113b, 114b. The labels include visible indicia 801.

FIG. 1C representatively illustrates a perspective view of labeled baggage 701 in accordance with the present invention. The labeled baggage includes a purse, 711c, with an exterior surface 411c, upon which are labels 111c, 112c, 113c, 114c. The labels include visible indicia 801 (not all are numbered). Two labels 111c and 112c are affixed to a flap of the purse; the flap normally facing the interior surface of the purse when the flap is closed. Two other labels 113c and 114c are on the main body of the purse and face outwardly. Labels 112c and 114c are positioned to come into contact with each other when the flap of the purse is closed; additionally labels 111c and 111d are positioned to come into contact with each other when the flap of the purse is closed.

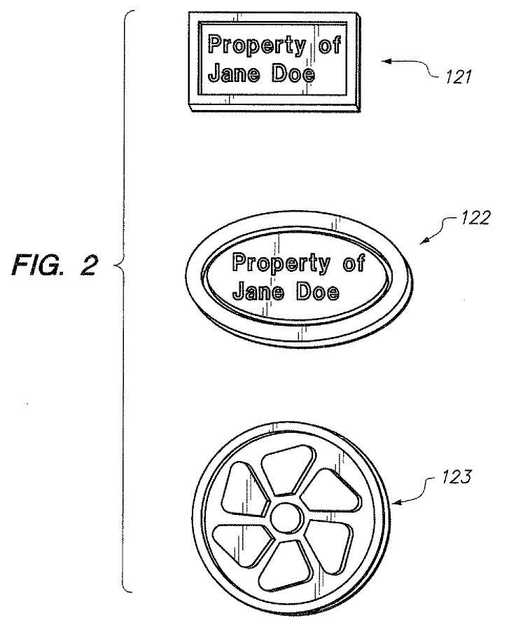

FIG. 2 representatively illustrates perspective views of labels 121, 122, 123 showing representative shapes and suggesting indicia on labels of the present invention. Two labels 121, 122 illustrate labels primarily bearing informational indicia; and one label 123 illustrates a label primarily bearing decorative indicia.

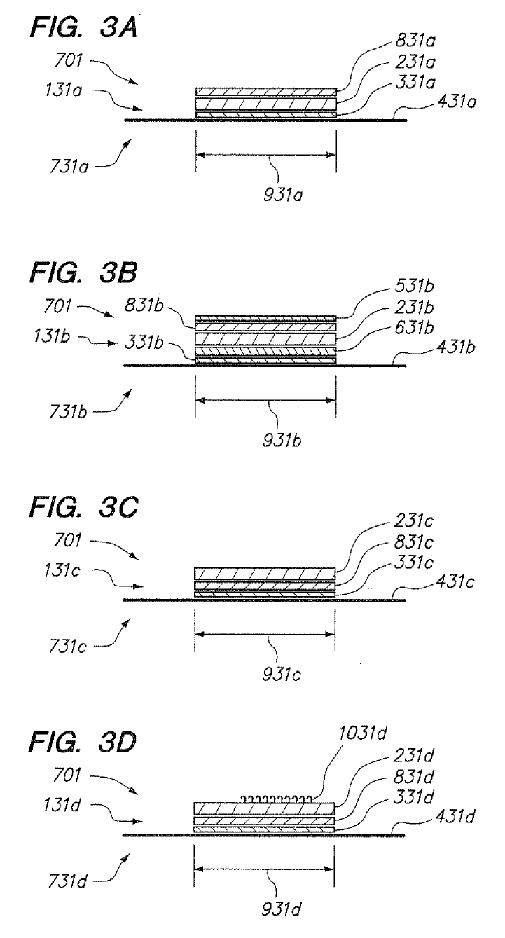

FIG. 3A representatively illustrates a cross-sectional view of labeled baggage 701 in accordance with the present invention. The labeled baggage includes a piece of baggage 731a, with an exterior surface 431a. The exterior surface of the baggage includes a labeling surface region 931a. The labeling surface is adhesively bonded to a label 131a through an adhesive layer 331a to the reverse side of a non-fibrous polymer layer 231a. The obverse side of the non-fibrous polymer layer constitutes the obverse facing of the label, and includes indicia 831a that are printed or otherwise provided.

FIG. 3B representatively illustrates a cross-sectional view of labeled baggage 701 in accordance with the present invention. The labeled baggage includes a piece of baggage 731b, with an exterior surface 431b. The exterior surface of the baggage includes a labeling surface region 931b. The labeling surface is adhesively bonded to a label 131b through an adhesive layer 331b to the reverse side of a barrier layer 631b. The obverse side of the barrier layer is in contact with the reverse side of a non-fibrous polymer layer 231b. The obverse side of the non-fibrous polymer layer is in contact with indicia 831b and the reverse side of a transparent or translucent fibrous layer 531b. The obverse facing of the fabric layer constitutes the obverse facing of the label. In alternate embodiments the indicia can be printed on the obverse facing of the non-fibrous polymer layer, the indicia can be printed on the reverse facing of the fibrous layer, or the indicia can be applied as a separate layer.

FIG. 3C representatively illustrates a cross-sectional view of labeled baggage 701 in accordance with the present invention. The labeled baggage includes a piece of baggage 731c, with an exterior surface 431c. The exterior surface of the baggage includes a labeling surface region 931c. The labeling surface is adhesively bonded to a label 131c through an adhesive layer 331c to the reverse side of a transparent or translucent non-fibrous polymer layer 231c. The reverse side of the non-fibrous polymer layer includes indicia 831c. that are printed or otherwise provided. The obverse side of the non-fibrous polymer layer constitutes the obverse facing of the label.

FIG. 3D representatively illustrates a cross-sectional view of labeled baggage 701 in accordance with the present invention. The labeled baggage includes a piece of baggage 731d, with an exterior surface 431d. The exterior surface of the baggage includes a labeling surface region 931d. The labeling surface is adhesively bonded to a label 131d through an adhesive layer 331d to the reverse side of a transparent or translucent non-fibrous polymer layer 231d. The reverse side of the non-fibrous polymer layer includes indicia 831d that are printed or otherwise provided. Hook portions of hook-and-loop fasteners 1031d are bonded onto, or molded into, the obverse side of the non-fibrous polymer layer.

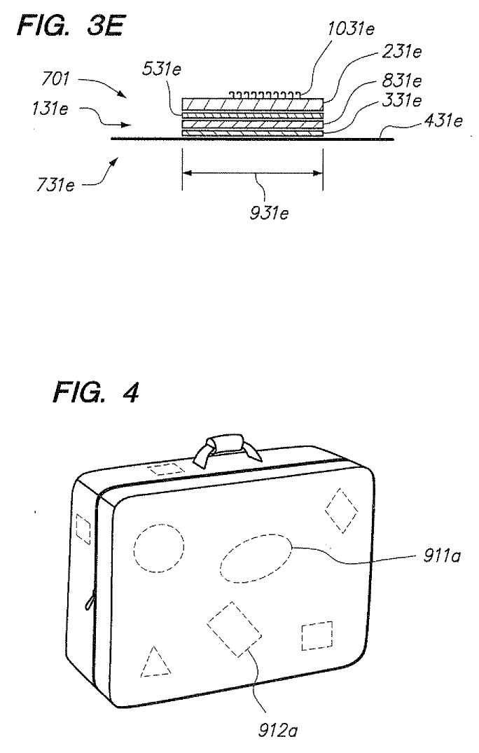

FIG. 4 representatively illustrates a perspective view of a piece of baggage representing a component of the present invention. The baggage, a suitcase, includes an exterior surface. The exterior surface of the baggage includes a plurality of labeling surface regions including labeling surface regions 911a and 911b. Upon these labeling surface regions, labels can be attached providing the labeled baggage of the present invention.

Labels

The label includes a tough, non-fibrous polymer layer. Exemplary materials for the non-fibrous polymer layer include polyvinyl chloride (hereinafter “PVC”), natural and synthetic rubbers, polyolefins, polyhydroxy alkanotes, and other polymers and polymer blends. Compositions commonly known as rubberized plastics can also be advantageously used as the non-fibrous polymer layer.

Polymers that either inherently, or as formulated, have a glass transition temperature (Tg) of less than 0° C. are generally preferred for the non-fibrous polymer layer. In additional to the base polymer, the non-fibrous polymer layer can include plasticizers, fillers and pigments.

For the purpose of various embodiments of the invention, natural rubber, polyethylene and other polymers with a glass transition temperature below 0° C. are effectively used as non-fibrous polymer layer materials without plasticization.

In some embodiments of the invention, the non-fibrous polymer layer comprises a polymer that inherently has Tg significantly above 0° C.; such relatively high Tg polymers benefit from plasticization. In particular, PVC is advantageously plasticized; common plasticizers for PVC include phthalates and benzoates and other aromatic esters. Unfortunately, plasticizers can exude from plastics, i.e. migrate to the surface, as the plasticized polymer ages, or upon exposure to temperature/humidity cycles or other environmental conditions. In particular this phenomenon occurs with PCV.

Considering the label 131b illustrated in FIG. 3B, the non-fibrous polymer layer 231b comprises a plasticized PVC. A barrier layer 631b is interposed between the non-fibrous polymer layer and the adhesive layer 331b. A function of the barrier layer is to prevent migration of plasticizer from the non-fibrous polymer layer into the adhesive, thereby maintaining adhesive quality. If a barrier layer is not used, plasticizer can deleteriously impact adhesive performance. Contamination of adhesive with plasticizer can render the adhesive soft and “gooey” resulting in cracking, peeling and loss of adhesion. Barrier layers are typically thin layers of high Tg polymers, such as poly (methyl methacrylate). A barrier layer, sometimes referred to as a “finishing” layer, can be comprised of DEGALAN(®) M 912, M 914 or M920; these materials are commercially available from Rohm GmbH & Co. KG, Chemische Fabrik, Darmstadt, Germany.

In FIGS. 3A and 3B the indicia 831a, 831b are on the obverse side of the non-fibrous polymer layers 231a, 231b; so the non-fibrous polymer layers can be opaque yet not obscure the indicia. Opacifying agents, pigments, additives to promote surface texture, and additives that result in a pearlescent, opalescent, iridescent, or a highly reflective surface can be included in the non-fibrous polymer layer formulation.

In FIGS. 3C and 3D the indicia 831c, 831d are on the reverse side of the non-fibrous polymer layers 231c, 231d; so in these illustrated embodiments of the invention it is desirable that the non-fibrous polymers layers be transparent or translucent, to enable a person using the labeled baggage to read the indicia.

In FIG. 3B the label 131b includes a fibrous layer 531b on the obverse side of the label. In one illustrative example, the label comprises a non-fibrous polymer layer made of a 0.8 mm thick polyethylene film, with a spunbond polyethylene nonwoven fabric thermally bonded to the obverse surface of the film. In an alternate embodiment a woven nylon fabric is adhesively laminated to the surface of the film. In other embodiments the fibrous surface is a flocked layer, of cellulose acetate fibers, bonded to the surface with a rubber-based adhesive.

A fibrous layer in label can mechanically reinforce the non-fibrous polymer layer, and can be a useful surface upon which to print indicia. Additionally, when placed on the obverse facing of the label, the fibrous surface can add an attractive surface and a surface with a desirable texture. FIG. 3E shows a further embodiment of the invention with a fibrous layer 531e on the reverse side of the non-fibrous polymer layer 231e.

In some embodiments of the invention, the label includes one or more foam layers. In FIG. 3B and FIG. 3E elements 531b and 531e can represent foam layers. A foam layer can comprise either the obverse or the reverse facing of the label; alternatively, the non-fibrous polymer layer can consist of two layers, with a foam layer in between. Open and closed cell polyurethane and polyethylene foams can advantageously provide a soft, cushioned surface; thermal, sound or electrical insulation; or absorbent capacity.

The reverse of the label comprises an adhesive layer 331a, 331b, 331c, 331d, 331e. The adhesive can cover more than 25%, more than 50%, more than 85%, or more than 95% of the reverse surface of the label. An adhesive layer of 0.2 mm to 2.0 mm thickness is generally satisfactory to secure the label to the baggage; alternatively a 0.3 mm to 1.5 mm, or 0.5 mm to 1.0 mm thick adhesive layer can secure the label to the baggage.

Molten adhesives can be applied to the label by extruding, spraying, slot coating, using a transfer roll or printing. The adhesive can be applied in swirls, discrete dots, and other patterns including uniform coatings. Alternatively, adhesives in the form of powders, latices, and in solution can be used. In certain embodiments of the invention adhesive is applied using a tape transfer method; that is, an adhesive is applied to a release tape, and subsequently the adhesive is transferred from the release tape to the label.

Desirable attributes of adhesives for various aspects of the invention include the capability of applying the adhesive in a temperature range of 10-200° C., 15-100° C., or 20-50° C. As most baggage has a textured finish, it is desirable that the adhesive bond well to uneven surfaces including fabrics.

It is generally desirable that the label stay bonded to the baggage during “normal” use. In the context of this invention, normal use includes exposure to weather conditions and rough handling. The adhesives desirably maintain a secure bond between the label and the baggage in a temperature range of −20 to 80° C., −15 to 60° C., or −10 to 40° C. Additionally, the adhesives should be resistant to prolonged exposure to high humidity and incidental exposure to liquid water. Furthermore, ultraviolet light resistance is a desirable attribute for the adhesive.

For various embodiments of the invention, it is desirable that the label be “cleanly removable” from the luggage. In this context cleanly removable means that at a temperature of 17-37° C., or at about 22° C. the label can be removed by slowly pulling up on an edge of the label without leaving noticeable residue. In some embodiments of the invention the label can be cleanly removed from the baggage by pulling the label off the baggage at about 22° C., without the use of solvents or abrasives, without damaging the baggage, and, without leaving noticeable residue on the baggage. Evidence of damaging the baggage would be removal of coatings or layers of fabric; mere removal of a few loose fibers from the baggage would not constitute damage. Noticeable residue includes bits of adhesive or label material that remains on the labeling surface after the label is removed. Noticeable residue includes visually observable residue and “stickiness” as a result of residual adhesive. To be cleanly removable, the bond between the non-fibrous polymer layer (or the barrier layer) and the adhesive must be stronger than the bond between the adhesive and the baggage; additionally, the cohesive strength of the adhesive itself must be greater than the bond between the adhesive and the baggage.

Rubber based or ethylene-vinyl acetate based adhesives are suitable for certain embodiments of the invention. Furthermore, acrylic pressure sensitive adhesives are particularly suitable for some embodiments of this invention. FT 1126 high tack acrylic transfer adhesive from Avery Dennison in Framingham, Mass. has been successfully used to bond the label to the baggage for certain embodiments of this invention. Alternatively, VHB(™) 9469 PC adhesive transfer tape available from 3M, St. Paul, Minn. can be used.

In the foregoing discussion, it has been stated that adhesive is applied to the label. Alternatively, adhesive can be applied to a labeling surface of the bag, and then the label applied to the adhesive-treated labeling surface. In other embodiments of the instant invention, the label may additionally be attached to the non-fibrous polymer layer using stitch bonding, rivets, or other means.

Indicia

The labeled baggage includes indicia that are visible when the obverse facing of the label is observed using visible or ultraviolet light. The indicia can reside on the non-fibrous polymer layer or on other layers of the label. Conventional printing techniques can be used to print continuous strips of the non-fibrous polymer layer. Alternatively, pieces of the non-fibrous polymer layer cut to the desired size of the label can be individually printed. Suitable printing techniques include rotogravure, intaglio, embossing, lithography, stenciling and screen printing. In some embodiments of the invention indicia are hand drawn on the non-fibrous polymer layer.

FIG. 3B illustrates another method of providing indicia 831b to the label, involving separately printing a carrier sheet 531b, then incorporating the printed sheet into the label 131b. In other embodiments of the invention, a photograph can be printed on fabric or paper, then the fabric or paper is adhesively bonded to the obverse face of the non-fibrous polymer layer. The printed side of the fabric or paper is placed either towards or away from the non-fibrous polymer layer. The advantages of the print on the non-fibrous polymer layer side of the fabric include improved durability of the print and a soft, muted appearance. The advantages of print on the side away from the non-fibrous polymer layer (i.e. on the outside surface of the label) include sharper images and the potential for bolder colors and contrast.

The indicia can be informational, decorative, or various combinations thereof. Example of suitable indicia include representations of activities; animal breeds; animal representations (hoofs, paws, tongues, etc); animals; aquariums; articles of clothing; astronomical representations (stars, planets, comets, moons, etc); awareness campaigns names/identities/initiatives; bar codes; body parts; books; cartoons; cityscapes; clubs and organization names/identities; commemorative events; dinosaurs; expressions of emotions and humor; faces; first or last names; flags; flowers and nature; fraternities/sororities; good luck charms; Greek letters; health club names/identity; identification “This bag belongs to . . . ”; imaginary characters (monsters, dragons); landmarks; landscapes; letters and numbers; licensed characters; lines to write personally identifying information; means of transportation (cars, trucks, etc); movies; museums; music/bands; musical instruments; names; national parks; numbers; place identification (“I love Roma”, etc); playing cards; political parties/candidates/initiatives; product branding campaigns; puzzle pieces; quotations; representations of nationality; ribbons; scenery; seasonal representations; shoes; sports equipment; stones and jewels; symbols; vintage travel scenes; warning notices (allergy alerts, etc); words; zodiac signs; and logos representing: businesses; cruise lines; hotels; resorts; sports; organizations; teams; theme parks; and travel companies.

Other decorative effects may be achieved by dispersing reflective, iridescent or opalescent particles on the surface of, or within the non-fibrous polymer layer or other layers of the label.

Indicia that fluoresce when exposed to ultraviolet, or “black light” can serve decorative, informational or security purposes. Additionally, light emitting diodes (LED) can be embedded or otherwise incorporated into the label or other parts of the labeled baggage system. The LED can be configured to provide decorative, informational or security images. LUMALIVE (Koninklijke Philips Electronics N.V. with offices in Eindhoven, Netherlands) is a LED system adapted for textile use, and is suitable for the present invention.

In some embodiments of the invention, indicia are uniquely associated with the owner of the labeled baggage, e.g. the indicia can be the owner's name, an airline ticket number, or a bar code that can be interpreted to reveal the owner of the labeled baggage, or the name of a business that owns the labeled baggage.

The label may be of any size and shape consistent with the decorative and functional features desired and the size of the baggage to which the label is to be attached. Generally however, sharp points on the label should be avoided, because at such points the label is more likely to loosen.

While not considered “indicia” in a traditional sense, another way to convey information in the labeled baggage is to embed or otherwise incorporate one or more radio frequency identification devices (RFID) in the labeled baggage. In one embodiment the RFID is placed on the labeling surface of the baggage, then the label covers the RFID and its associated antenna. Concealing the RFID under the label makes the RFID less susceptible to damage than if it were surface mounted.

Coefficient of Friction

Aside from the communication benefits of the print, it can have functional aspects. For example, the print can comprise a rubbery, high coefficient of friction material, providing a non-slip obverse surface to the label. This will help prevent the baggage from sliding or shifting. Such a feature can be advantageous when transporting the baggage. Alternatively the label can have a low coefficient of friction obverse surface, enabling the baggage to more easily slide. Hard finish coats, i.e. high Tg polymer coatings, such as styrene and methyl methacrylate based polymers commonly provide low coefficient of friction surfaces.

For the purposes of the present invention, a suitable technique for determining the relative coefficient of friction values of outer surface of the baggage (proximate the label) to the outer surface of the label employs the following procedure. The test procedure includes sliding a label across a fabric (or other material that represents the surface of the baggage proximate the label; and measuring the force required to slide one material across the other. Kinetic coefficient of friction values, rather than static coefficient of friction values are employed for describing an aspect of the present invention. For many materials, such as the fabric materials described in the present specification, the static coefficient of friction can be greater than the kinetic coefficient of friction. For example, the difference can be about 10%-100%. While not intending to be bound by any particular theory, it is believed that the kinetic coefficient of friction values are more reproducible and are more representative of actual product use conditions. The kinetic coefficient of friction can be determined using ASTM method D 1894-93, published December 1993; with the following particulars.

The following test procedure particularly refers to a “fabric” material. It should be readily appreciated, however, that such reference is merely exemplary. The term “fabric” in this context refers to the material that is the facing of the baggage proximate the label. Commonly then, “fabric” is a woven nylon fabric; but for many bags “fabric” can be a metal or plastic material representative of the outer face of the baggage. It is understood that the obverse of the label may also be a textile material, but in the context of this test procedure the term “fabric” is reserved for the surface material of the baggage proximate the label.

A MONITOR/SLIP & FRICTION™. Model 32-06 test apparatus is used with a 200.+−0.5 gram COF (Coefficient Of Friction) Testing Sled and foam, part number 32-06-02; both of which are available from Testing Machines, Inc., Amityville, N.Y. 11701-2882. This apparatus is equipped with a digital display, and the apparatus can automatically calculate and display the kinetic coefficient of friction.

Follow the manufacture's instructions for assembling and calibrating the instrument.

All of the following coefficient of friction tests are conducted at a rate of 15 cm/min±3 cm/min.

1) Specimens

Three distinct types of test specimens are used in this procedure: a large (22.9 cm square) fabric representative of the baggage surface proximate the label; a label, or representative section; and a piece of fabric of the same dimensions as the label.

Fabric representative of the fabric proximate the label is cut into the shape of a 22.9 cm square and remains in a stationary position during testing. The fabric should be held securely, so that it does not shift or buckle during testing. Depending on the characteristics of the fabric, to prevent shifting or buckling, it may be desirable to mount the fabric square to a stiff cardboard backing using two-faced tape. This piece of fabric is referenced as the “large square of fabric” below.

For labels measuring less than 6.4 cm in the largest dimension, the entire label is used as the “label sample” in the following procedure. For labels larger than 6.4 cm in the largest dimension, the label is trimmed so that a representative 6.4 cm square (or as close as can be approximated depending on the geometry of the label) is used as the label sample.

A second piece of fabric is cut to the same size and shape as the label sample, this piece of fabric is designated as the “small square of fabric” below.

For the label specimens, the label sample is mounted to the sled so that the obverse facing of the label will be in contact with the fabric during testing. It is important that the label sample not shift during testing. Two-faced tape or clamps may be used to secure the label sample to the sled; in either case, it is important that only the label sample itself, not clamps or adhesive, make contact with the large square of fabric when the sled is moved.

For the control specimens, the small square of fabric is mounted to the sled so that the small square of fabric will be in contact with the large square of fabric during testing. It is important that the small square of fabric not shift during testing. Two-faced tape or clamps may be used to secure the label to the sled; in either case, it is important that only the small square of fabric itself, not clamps or adhesive, make contact with the large square of fabric when the sled is moved.

2) Test Directions

Some fabrics and some label materials have directionally-dependent coefficient of friction, so the COF determination requires that sets of eight measurements be taken with the label sample as follows.

four measurements with a first large square of fabric in a first orientation with:
the label sample in a first orientation;
the label sample rotated 90° from the first orientation;
the label sample rotated 180° from the first orientation; and
the label sample rotated 270° from the first orientation.

four measurements with the large square of fabric rotated 90° from the first orientation with:
the label sample in a first orientation;
the label sample rotated 90° from the first orientation;
the label sample rotated 180° from the first orientation; and
the label sample rotated 270° from the first orientation.

Then four measurements are taken with a second large square of fabric in a first orientation with:
the small square of fabric in a first orientation;
the small square of fabric rotated 90° from the first orientation;
the small square of fabric rotated 180° from the first orientation; and
the small square of fabric rotated 270° from the first orientation.

four measurements with the large square of fabric rotated 90° from the first orientation with:
the small square of fabric in a first orientation;
the small square of fabric rotated 90° from the first orientation;
the small square of fabric rotated 180° from the first orientation; and
the small square of fabric rotated 270° from the first orientation.

3) Operation of Instrument

a) Position the sled pin in the load cell mount, making sure that the sled is centered. Place the anti-skid guide over the sled.

b) Start the test by pressing the test key.

c) When the test is completed, lift the anti-skid guide and remove the sled.

d) Press enter, record the kinetic coefficient of friction.

e) Rotate or change the large square of fabric, label square or small square of fabric as indicated above, and repeat steps until eight readings are obtained for the label sample on large square of fabric combination and eight readings are obtained for the small square of fabric on large square of fabric combination.

4) Calculations

The mean of the eight kinetic COF results for the label sample on large square of fabric combination is calculated and recorded as COF(label).

The mean of the eight kinetic COF results for the small square of fabric on large square of fabric combination is calculated and recorded as COF(control).

The ratio of coefficient of friction for the label to the control coefficient of friction for the control=

COF(label/control)=COF(label)/COF(control)

A label surface is considered to have a significantly higher coefficient of friction than the surface of the baggage proximate the label if COF(label/control)>1.5, or if COF(label/control)>2, or if COF(label/control)>3.

A label surface is considered to have a significantly lower coefficient of friction than the surface of the baggage proximate the label if the coefficient of friction of the label surface against the surface of the baggage is COF(label/control)<0.75, or COF(label/control)<0.50, or COF(label/control)<0.25.

Functional Features

In certain embodiments of the invention the print comprises grit or abrasive materials. For certain sports, camping, or cosmetic applications, it may be advantageous for the label to have a rough surface, approximating an emery board.

In still further embodiments of the invention, a fabric is bonded to the obverse facing of the non-fibrous polymer layer wherein the fabric comprises one part of a hook-and-loop fastener system. Hook-and-loop fastener systems are available from Velcro USA with offices in Manchester, N.H. and 3M with offices in St. Paul, Minn. A hook-and-loop fastener system or microhook-and-loop fastener system can advantageously allow the consumer to temporarily affix their baggage to a wall or other suitable surface, or to affix two pieces of baggage together. A portion of the baggage surface may be configured to bond to the hook-and-loop fastener on the label; in that way the label can conveniently be used to hold the bag open or closed.

FIG. 3D illustrates the non-fibrous polymer layer 231d molded to include hooks 1031d as part of a hook-and-loop system. FIG. 3E illustrates the non-fibrous polymer layer 231e molded to include loops 1031e as part of a hook-and-loop system. In further embodiments of the invention, as shown in FIG. 1C the hook-and-loop system is configured as a pair of labels, one label 111c with hook functionality and another label 114c, with loop functionality; the labels being positioned to interact with each other when the flap on the purse is closed. In additional embodiments of the invention, labels 112c and 113c may have cohesive properties, such that the obverse facing of two labels stick to each other when brought into contact.

Baggage

The term “baggage” generally includes closable containers larger than about 10 cm×10 cm×1 cm and smaller than about 3 m×1 m×1 mm, and that weigh more than about 10 grams and less than about 50 kilograms. Exemplary baggage includes: bowling ball bags; clothing; computers; cosmetic bags; fanny packs; golf bags; hard-case luggage and bags; lunchboxes; musical instrument bags; purses; skates; ski bags; sleeping bags; sporrans; tackle boxes; tennis racket bags; tents; tool boxes; and wallets.

The surface of the bag that is adhesively attached to the label can be made of various plastics, coatings, or metals. Optionally the surface is made of nylon, (Cordura, ballistic, no-tear, rip-stop, etc), kevlar, polyester, vinyl, polycarbonate, or leather.

As shown in FIGS. 1A and 1B, most commonly labels are placed in prominent positions on the baggage. Generally it is desirable to position the label on a top or side surface so that the baggage can be easily identified among other more-or-less similar bags. But for some applications, as shown in FIG. 1C, it is preferred that labels be in less conspicuous locations. The label can, for example, be affixed on the inside facing of a flap of the baggage. In still further embodiments labels can be placed on either facing of a flap so that whether the flap is open or closed, a label is visible.

Method

In one illustrative example of a method for making an embodiment of the invention, a roll of white vinyl, i.e. plasticized PVC, is used as a non-fibrous polymer layer. The vinyl is about 1 mm thick. One side of the vinyl is selected as the obverse side and the other side is the reverse. The reverse of the vinyl is finished with a light coating of DEGLAN® M 912. After the finish coating dries, a layer of Avery Dennison FT 1126 adhesive is applied over the finish coating, with the release sheet left attached to the side of the adhesive away from the non-fibrous polymer layer. Using a die cutter, circles measuring about 6 cm in diameter are cut from the sheet.

The obverse side of the label is decorated using a permanent marker. The release sheet is removed from the reverse of the decorated label, exposing the adhesive layer. The label is then applied by hand to a soft nylon backpack. The backpack is used to carry books back and forth to school for several weeks. Then the label is removed by firmly grasping an edge and slowly pulling up. The label is cleanly removed and leaves no noticeable residue on the backpack.

In alternate embodiments the non-fibrous polymer layer is a non-plasticized, inherently flexible polymer, so no finishing, i.e. barrier layer, is required.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

I claim:

1. Labeled baggage comprising:
a label comprising:
an obverse facing and a reverse facing; and
a non-fibrous polymer layer;
at least one indicia apparent when the obverse facing is observed;
an adhesive layer at least partially covering the reverse facing of the label;
a piece of baggage comprising a labeling surface wherein the entire adhesive layer is in contact with, or proximate, the labeling surface; and wherein
the adhesive layer bonds the label to the baggage.

2. The labeled baggage of claim 1 wherein
the non-fibrous polymer layer comprises a vinyl chloride polymer or copolymer and a plasticizer, and wherein
interposed between the non-fibrous polymer layer and the adhesive layer is a barrier layer that prevents the plasticizer from contaminating the adhesive.

3. The labeled baggage of claim 1 wherein,
the adhesive comprises an acrylic pressure sensitive adhesive.

4. The labeled baggage of claim 3 wherein,
the coating of adhesive is 0.3 mm to 1.5 mm thick.

5. The labeled baggage of claim 1 wherein the indicia are on the obverse surface of the non-fibrous polymer layer.

6. The labeled baggage of claim 1 wherein the labeling surface is a fibrous layer comprising synthetic fibers.

7. The labeled baggage of claim 1 wherein the ratio of the coefficient of friction of the label against the surface of the baggage proximate the label to the coefficient of friction of the surface of the baggage proximate the label to itself, COF(label/control), is greater than 2.

8. The labeled baggage of claim 1 wherein the ratio of the coefficient of friction of the label against the surface of the baggage proximate the label to the coefficient of friction of the surface of the baggage proximate the label to itself, COF(label/control), is less than 0.75.

9. The labeled baggage of claim 1 wherein the labeling surface is at least partially positioned on an interior surface of the baggage.

10. The labeled baggage of claim 1 wherein the label can be removed from the baggage by pulling the label off the baggage at about 22° C.,
without the use of solvents or abrasives,
without damaging the baggage, and
without leaving noticeable residue on the baggage.

11. The labeled baggage of claim 1 wherein the label further comprises a fibrous layer.

12. The labeled baggage of claim 11 wherein the fibrous layer at least partially covers the obverse facing of the non-fibrous polymer layer.

13. Labeled baggage comprising:
at least one label comprising:
an obverse facing and a reverse facing; and
a non-fibrous polymer layer about 0.2 mm to 10 mm in thickness;
at least one indicia apparent when the obverse facing is observed; and
an adhesive layer at least partially covering the reverse facing of the label wherein the adhesive layer is 0.5 mm to 1.5 mm thick.
a piece of baggage comprising a labeling surface wherein the entire adhesive layer is in contact with, or proximate, the labeling surface; and wherein
the adhesive layer bonds the label to the baggage; and wherein
wherein the label can be removed from the baggage by pulling the label off the baggage at about 22° C.,
without the use of solvents or abrasives,
without damaging the baggage, and
without leaving noticeable residue on the baggage

14. The labeled baggage of claim 13 wherein
the obverse facing of a first label is configured as a first component of a hook-and-loop fastening system.

15. The labeled baggage of claim 13 wherein
the obverse facing of a second label is configured as a second component of a hook-and-loop fastening system, configured to engage with the first component.

16. The labeled baggage of claim 13 wherein the indicia are provided to the label prior to the label being affixed to the baggage.

17. The labeled baggage of claim 13 wherein the indicia are provided to the label after to the label is affixed to the baggage.

18. The labeled baggage of claim 13 wherein the indicia are uniquely associated with the owner of the labeled baggage.

19. The labeled baggage of claim 13 wherein the non-fibrous polymer layer is clear or translucent and the indicia are on or adjacent the reverse facing of the non-fibrous polymer layer.
